(19) United States
(12) Patent Application Publication
(10) Pub. No.: US 2003/0049042 A1
(43) Pub. Date: Mar. 13, 2003

(54) Corrugating air knife

(75) Inventor: Gregory V. Bogoshian, Rochester, NY (US)

Correspondence Address: Patent Documentation Center, Xerox Corporation, Xerox Square, 20th Floor, 100 Clinton Ave. S., Rochester, NY, 14644, US

(73) Assignee: Xerox Corporation

(21) Appl. No.: 10/043,188

(22) Filed: Jan. 14, 2002

Related U.S. Application Data
(60) Provisional application No. 60/315,233, filed on Aug. 27, 2001.

(51) Int. Cl. G03G 21/20

(52) U.S. Cl. 399/92; 239/568

(57) ABSTRACT

A corrugating air knife for stripping a sheet from a fusing member. The air knife includes a manifold connected to an air supply source and has an outlet which directs a flow of air across a sheet path adjacent the fuser. The air knife further includes ribs through which air flows to create localized air flows which when directed at the sheet cause it to corrugate as it separates from the fuser. The corrugation increases the beam strength and prevents wrap jams.

This application is based on a provisional application No. 60/315,233, filed Aug. 27, 2001.

This invention relates generally to an air knife and more particularly, concerns a multi function corrugating air knife to remove a sheet from a fusing member in a full color electrophotographic printing machine.

In a typical electrophotographic printing process, a photoconductive member is charged to a substantially uniform potential so as to sensitize the surface thereof. The charged portion of the photoconductive member is exposed to a light image of an original document being reproduced. Exposure of the charged photoconductive member selectively dissipates the charges thereon in the irradiated areas. This records an electrostatic latent image on the photoconductive member corresponding to the informational areas contained within the original document. After the electrostatic latent image is recorded on the photoconductive member, the latent image is developed by bringing a developer material into contact therewith. Generally, the developer material comprises toner particles adhering triboelectrically to carrier granules. The toner particles are attracted from the carrier granules to the latent image forming a toner powder image on the photoconductive member. The toner powder image is then transferred from the photoconductive member to a copy sheet. The toner particles are heated to permanently affix the powder image to the copy sheet.

The foregoing generally describes a typical black and white electrophotographic printing machine. With the advent of multicolor electrophotography, it is desirable to use an architecture which comprises a plurality of image forming stations. One example of the plural image forming station architecture utilizes an image-on-image (IOI) system in which the photoreceptive member is recharged, reimaged and developed for each color separation. This charging, imaging, developing and recharging, reimaging and developing, all followed by transfer to paper, is done in a single revolution of the photoreceptor in so-called single pass machines, while multipass architectures form each color separation with a single charge, image and develop, with separate transfer operations for each color.

In color machines it is desirable to be able to fix images to a wide latitude of substrates. It is also desirable that an image with a range of toner area coverage from very high to very low be processed without causing fusing problems or image degradation.

It is therefore desirable to have a device to assist in removing a sheet from a fuser device regardless of the sheet size and/or weight and the toner coverage thereon.

In accordance with one aspect of the present invention, there is provided a corrugating air knife, comprising a manifold connected to an air supply source, wherein said manifold defines an outlet for providing a directed stream of air from said manifold and a plurality of secondary outlets connected to said manifold which direct a localized stream of air to corrugate a sheet.

In accordance with another aspect of the invention there is provided a device for fusing a toner image to a sheet comprising a heated fusing roll, a pressure roll in circumferential contact with said heated fusing roll to form a nip therebetween, a manifold, adjacent said the nip formed by said heated fusing roll and said pressure roll, said manifold connected to an air supply source, wherein said manifold defines an outlet for providing a directed stream of air from said manifold and a plurality of secondary outlets connected to said manifold which direct a localized stream of air to corrugate a sheet.

In accordance with yet another aspect of the invention there is provided an electrophotographic printing machine having a fusing apparatus, comprising a print engine for forming and depositing a toner image on a substrate, a heated fusing roll, a pressure roll in circumferential contact with said heated fusing roll to form a nip therebetween, a manifold, adjacent said the nip formed by said heated fusing roll and said pressure roll, said manifold connected to an air supply source, wherein said manifold defines an outlet for providing a directed stream of air from said manifold and a plurality of secondary outlets connected to said manifold which direct a localized stream of air to corrugate a sheet.

Other features of the present invention will become apparent as the following description proceeds and upon reference to the drawings, in which:

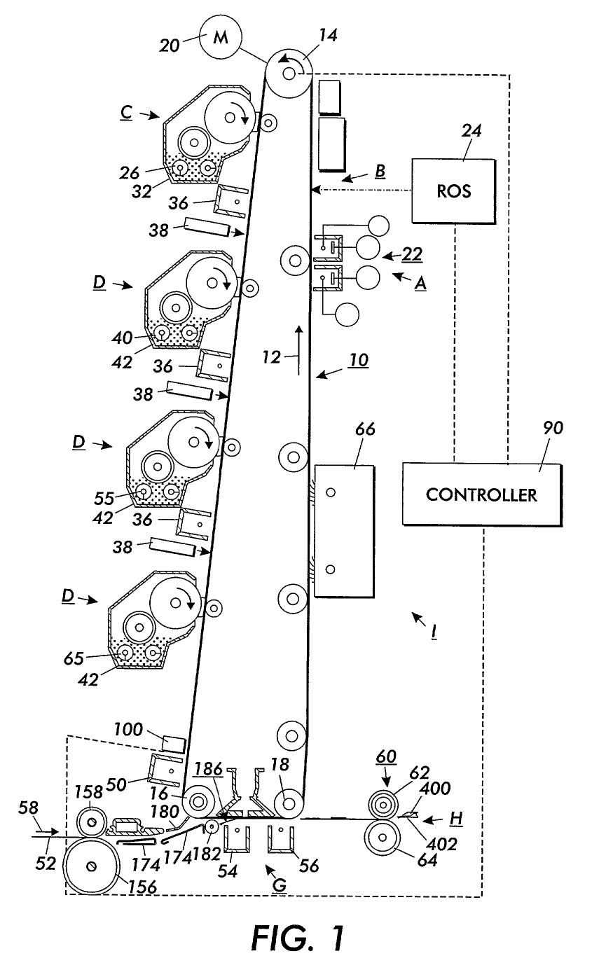

FIG. 1 is a schematic elevational view of a full color image-on-image single-pass electrophotographic printing machine utilizing the device described herein;

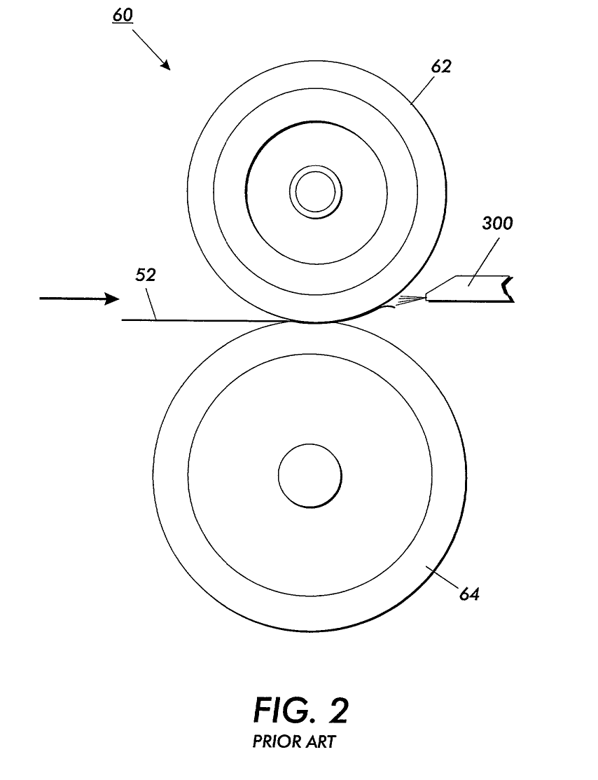

FIG. 2 is a side view illustrating a prior art fusing device with an air knife relative to the FIG. 1 printing machine;

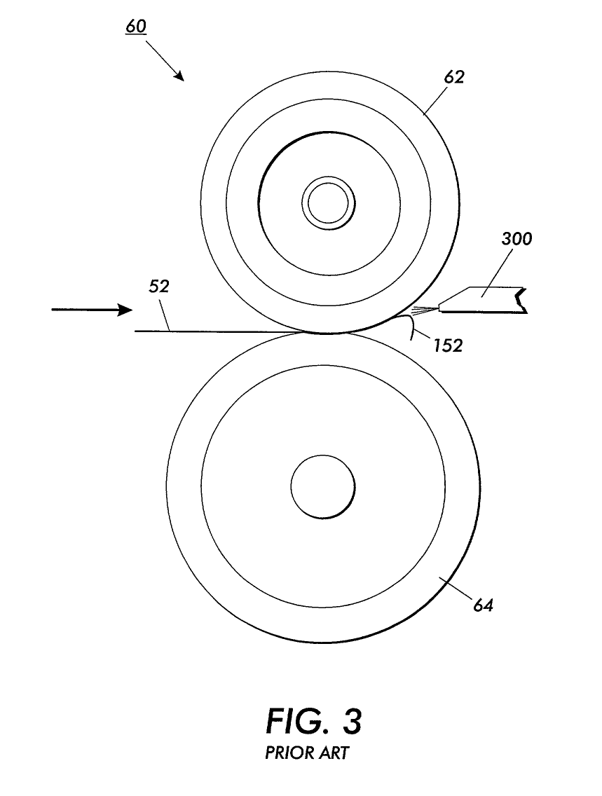

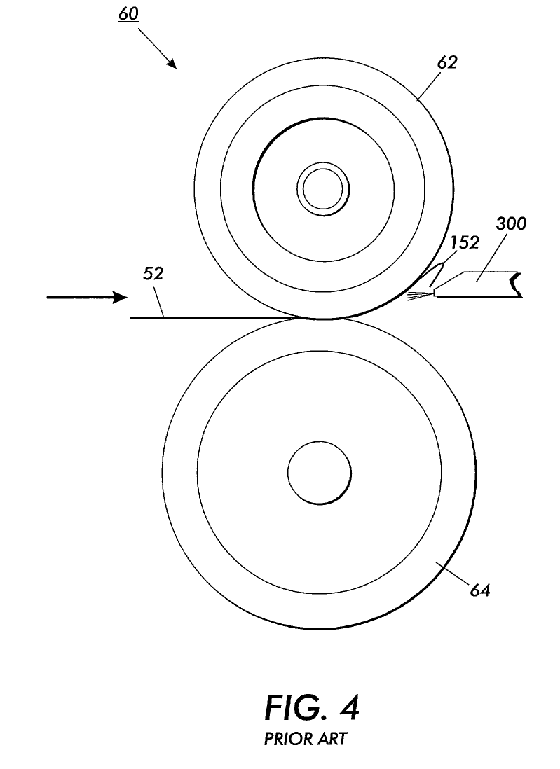

FIGS. 3 and 4 are side views illustrating the default that can occur with the prior art fusing device and method relative to the FIG. 1 printing machine;

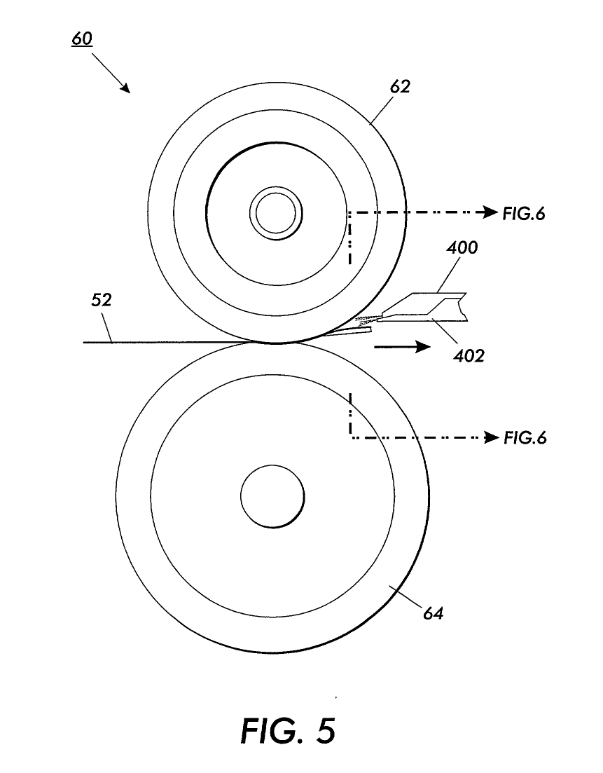

FIG. 5 is a side view illustrating the improved fusing device having the multi function air knife and corrugator relative to the FIG. 1 printing machine; and

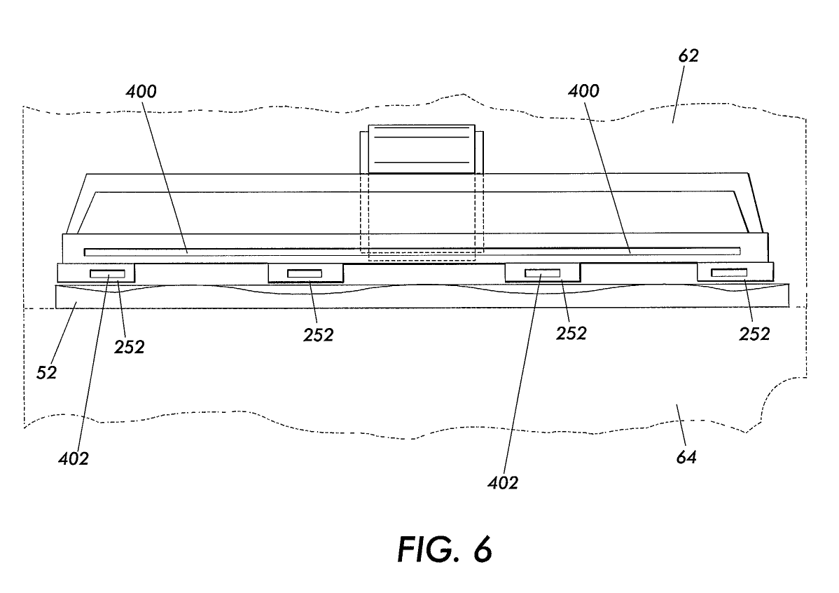

FIG. 6 is a schematic cut away end view illustrating the corrugating effect of the multi function air knife.

This invention relates to printing system which is used to produce color output in a single pass of a photoreceptor belt. It will be understood, however, that it is not intended to limit the invention to the embodiment disclosed. On the contrary, it is intended to cover all alternatives, modifications and equivalents as may be included within the spirit and scope of the invention as defined by the appended claims, including a multi-pass color process system, a single or multiple pass highlight color system and a black and white printing system.

Turning now to FIG. 1, the electrophotographic printing machine of the present invention uses a charge retentive surface in the form of an Active Matrix (AMAT) photoreceptor belt 10 supported for movement in the direction indicated by arrow 12, for advancing sequentially through the various xerographic process stations. The belt is entrained about a drive roller 14 and tension and steering rollers 16 and 18 respectively; roller 14 is operatively connected to a drive motor 20 for effecting movement of the belt through the xerographic stations.

With continued reference to FIG. 1, a portion of belt 10 passes through charging station A where a corona generating device, indicated generally by the reference numeral 22, charges the photoconductive surface of belt 10 to a relative high, substantially uniform, preferably negative potential.

Next, the charged portion of photoconductive surface is advanced through an imaging station B. At exposure station B, the uniformly charged belt 10 is exposed to a laser based output scanning device 24 which causes the charge retentive surface to be discharged in accordance with the output from the scanning device. Preferably the scanning device is a laser Raster Output Scanner (ROS). Alternatively, the ROS could be replaced by other xerographic exposure devices such as LED arrays.

The photoreceptor, which is initially charged to a voltage V_{c}, undergoes dark decay to a level V_{ddp} equal to about −500 volts. When exposed at the exposure station B it is discharged to V_{image} equal to about −50 volts. Thus after exposure, the photoreceptor contains a monopolar voltage profile of high and low voltages, the former corresponding to charged areas and the latter corresponding to discharged or image areas.

At a first development station C, developer structure, indicated generally by the reference numeral 32 utilizing a hybrid jumping development (HJD) system, the development roll, better known as the donor roll, is powered by two development fields (potentials across an air gap). The first field is the AC jumping field which is used for toner cloud generation. The second field is the DC development field which is used to control the amount of developed toner mass on the photoreceptor. The toner cloud causes charged toner particles 26 to be attracted to the electrostatic latent image. Appropriate developer biasing is accomplished via a power supply. This type of system is a noncontact type in which only toner particles (magenta, for example) are attracted to the latent image and there is no mechanical contact between the photoreceptor and a toner delivery device to disturb a previously developed, but unfixed, image.

The developed but unfixed image is then transported past a second charging device 36 where the photoreceptor and previously developed toner image areas are recharged to a predetermined level.

A second exposure/imaging is performed by imaging device 38 which comprises a laser based output structure and is utilized for selectively discharging the photoreceptor on toned areas and/or bare areas, pursuant to the image to be developed with the second color toner. At this point, the photoreceptor contains toned and untoned areas at relatively high voltage levels and toned and untoned areas at relatively low voltage levels. These low voltage areas represent image areas which are developed using discharged area development (DAD). To this end, a negatively charged, developer material 40 comprising color toner is employed. The toner, which by way of example may be yellow, is contained in a developer housing structure 42 disposed at a second developer station D and is presented to the latent images on the photoreceptor by way of a second HSD developer system. A power supply (not shown) serves to electrically bias the developer structure to a level effective to develop the discharged image areas with negatively charged yellow toner particles 40.

The above procedure is repeated for a third image for a third suitable color toner such as cyan and for a fourth image and suitable color toner such as black. The exposure control scheme described below may be utilized for these subsequent imaging steps. In this manner a full color composite toner image is developed on the photoreceptor belt.

To the extent to which some toner charge is totally neutralized, or the polarity reversed, thereby causing the composite image developed on the photoreceptor to consist of both positive and negative toner, a negative pre-transfer dicorotron member 50 is provided to condition the toner for effective transfer to a substrate using positive corona discharge.

Subsequent to image development a sheet of support material 52 is moved into contact with the toner images at transfer station G. The sheet of support material is advanced to transfer station G by a sheet feeding apparatus to the pretransfer device which directs the advancing sheet of support material into contact with photoconductive surface of belt 10 in a timed sequence so that the toner powder image developed thereon contacts the advancing sheet of support material at transfer station G.

Transfer station G includes a transfer dicorotron 54 which sprays positive ions onto the backside of sheet 52. This attracts the negatively charged toner powder images from the belt 10 to sheet 52. A detack dicorotron 56 is provided for facilitating stripping of the sheets from the belt 10.

After transfer, the sheet continues to move, in the direction of arrow 58, onto a conveyor (not shown) which advances the sheet to fusing station H. Fusing station H includes a fuser assembly, indicated generally by the reference numeral 60, which permanently affixes the transferred powder image to sheet 52. Preferably, fuser assembly 60 comprises a heated fuser roller 62 and a backup or pressure roller 64. Sheet 52 passes between fuser roller 62 and backup roller 64 with the toner powder image contacting fuser roller 62. In this manner, the toner powder images are permanently affixed to sheet 52 after it is allowed to cool. After fusing, the sheet is separated from the fuser roll by the corrugating air knife, described in more detail below, to a chute, not shown, which guides the advancing sheets 52 to a catch tray, not shown, for subsequent removal from the printing machine by the operator.

After the sheet of support material is separated from photoconductive surface of belt 10, the residual toner particles carried by the non-image areas on the photoconductive surface are removed therefrom. These particles are removed at cleaning station I using a cleaning brush structure contained in a housing 66.

It is believed that the foregoing description is sufficient for the purposes of the present application to illustrate the general operation of a color printing machine.

As shown in FIG. 2, a sheet 52 passes between the heated roll 62 and the pressure roll 64 causing the toner image thereon to be fused to the sheet. In prior applications an air knife 300 provide a stream of air to assist in separating the fused sheet from the heated fuser roll. There is a default mode however which particularly with lighter weight sheets with a heavy toner image near the lead edge 152 of the sheet in which the sheet would either not separate from the fuser or due to the lack of beam strength of the sheet would retack to the fuser roll and cause a jam. As shown in FIGS. 3 and 4, the air blast from the air knife on a light weight sheet would cause the lead edge of the sheet to fold over while the imaged area “retacked” to the fuser roll 62. This would cause the sheet to wrap around the fuser roll 62 causing a jam as opposed to exiting through the sheet guide.

The corrugating air knife 400 utilizes a manifold 401 which directs stream of air across the width of the sheet but further has extra ribs 402 formed which have a air passage integral to the rib 402 as shown in FIG. 5. The localized stream of air which flows from the ribs 402 causes a lightweight sheet to corrugate due to the air stream which increases the beam strength of the sheet and prevents the lead edge of the sheet 152 from folding over and wrapping around the fuser. The ribs 402 also provide a gap between the sheet 52 and the main portion of the air knife 400 which helps prevent the sheet from being sucked toward the air knife and by the baffle due to Bernoulli effect. The localized jets from the ribs 402 also help to break the surface tension between the sheet 52 and the fuser heated roll 62 which allows the wall of air expelled by the air knife 400 to remove the sheet 52 from the roll 62.

In addition to utilizing the corrugating air knife the control for the air stream is modified to enhance the stripping effect of the air knife. In a traditional application a short burst of air was used to separate the lead edge of the sheet from the fuser roll and the air was then discontinued. In lightweight, heavily toned sheets this single burst of air did not prevent retack and wrap jams. The solution is to provide an initial burst of air utilizing the localized air jets 402 and then to continue the airstream at a lesser pressure to continue to assist in the separation of the sheet from the fuser. This continued air stream has the additional benefit of cooling the lighter weight sheets to help reduce the chance of hot offset or other damage to the image due to the image not being fully cooled. Heavier weight sheets do not absorb as much heat nor is the beam strength such that wrap jams are a problem so the air knife can be used less or even not at all depending of the sheet weight. The control for the air knife can be predetermined based on the sheet weight requested for a particular job or by sensing the weight of the sheet as it is processed in the machine and automatically adjusting the air knife in response to the sheet weight.

In recapitulation, there is provided a corrugating air knife for stripping a sheet from a fusing member. The air knife includes a manifold connected to an air supply source and has an outlet which directs a flow of air across a sheet path adjacent the fuser. The air knife further includes ribs through which air flows to create localized air flows which when directed at the sheet cause it to corrugate as it separates from the fuser. The corrugation increases the beam strength and prevents wrap jams.

It is, therefore, apparent that there has been provided in accordance with the present invention, a multi function air knife that fully satisfies the aims and advantages hereinbefore set forth. While this invention has been described in conjunction with a specific embodiment thereof, it is evident that many alternatives, modifications, and variations will be apparent to those skilled in the art. Accordingly, it is intended to embrace all such alternatives, modifications and variations that fall within the spirit and broad scope of the appended claims.

I claim:

1. A corrugating air knife, comprising:
a manifold connected to an air supply source, wherein said manifold defines an outlet for providing a directed stream of air from said manifold;
a plurality of secondary outlets connected to said manifold which direct a localized stream of air to corrugate a sheet.

2. A device for fusing a toner image to a sheet comprising:
a heated fusing roll;
a pressure roll in circumferential contact with said heated fusing roll to form a nip therebetween;
a manifold, adjacent said the nip formed by said heated fusing roll and said pressure roll, said manifold connected to an air supply source, wherein said manifold defines an outlet for providing a directed stream of air from said manifold;
a plurality of secondary outlets connected to said manifold which direct a localized stream of air to corrugate a sheet.

3. An electrophotographic printing machine having a fusing apparatus, comprising:
a print engine for forming and depositing a toner image on a substrate;
a heated fusing roll;
a pressure roll in circumferential contact with said heated fusing roll to form a nip therebetween;
a manifold, adjacent said the nip formed by said heated fusing roll and said pressure roll, said manifold connected to an air supply source, wherein said manifold defines an outlet for providing a directed stream of air from said manifold;
a plurality of secondary outlets connected to said manifold which direct a localized stream of air to corrugate a sheet.
